(19) United States
(12) Patent Application Publication
(10) Pub. No.: US 2010/0221470 A1
(43) Pub. Date: Sep. 2, 2010

(54) POLYMER VESSEL HAVING A CRYSTALLINITY GRADIENT

(75) Inventors: Mikael Derrien, Octeville Sur Mer (FR); Pierrick Protais, Octeville Sur Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, OCTEVILLE SUR MER (FR)

(21) Appl. No.: 12/663,385

(22) PCT Filed: Jun. 6, 2008
(86) PCT No.: PCT/FR08/00772

§ 371 Date: May 14, 2010

(30) Foreign Application Priority Data
Jun. 7, 2007 (FR) 0704065

(51) Int. Cl. B32B 1/08

(52) U.S. Cl. 428/35.7

(57) ABSTRACT

Polymer container (2), having an inside wall (42) and an opposed outside wall (43), the crystallinity rate of which exhibits a negative gradient of the side of the inside wall (42).

The invention concerns the manufacture of containers, by blowing or stretch-blowing from polymer blanks.

Hereinafter, the term “blank” will not only cover the notion of a preform, but also that of an intermediate container, that is to say an object having undergone a first blowing (which can be free) and intended to undergo a second to form the final container.

Among the polymers currently most used for manufacturing containers are the saturated polyesters and particularly PET (poly(-ethylene terephthalate)).

We would like to briefly point out that stretch-blowing of containers consists of taking a polymer blank that has been pre-heated, introducing this blank into a mold with the shape of the end container to be formed, then stretching the blank by means of stretch rod (also called a cane) and blowing pressurized gas into it (generally air) to pin the material flat against the wall of the mold.

Remarks Concerning PET

Here, we would like to make a few remarks concerning the physical and mechanical properties of PET, so as to better grasp what follows.

The invention is certainly not limited to the PET alone; however, given that this material is, at present, that most currently used for the stretch-blowing of containers, it would appear to be appropriate to study this example carefully.

Here following, the figures between the square brackets will refer to the documents listed in the bibliography attached to this description.

PET is a polyester obtained by polycondensation from terephtalic acid and from ethylene glycol. Its structure can be amorphous or partially crystalline (without however exceeding 50%). The possibility of going from one phase to another depends largely on the temperature: below its vitreous transition temperature (T_{g}≈80° C.), the micromolecular chains are quite mobile and the material is solid, with a solidified microstructure; above the fusion temperature T_{f} (about 270° C.), the bonds between the chains are destroyed and the material is liquid. Between these two temperatures, the chains are mobile and their conformation can change (See [2]).

More precisely, above T_{g} the chain movements made possible in the amorphous disordered zones permit greater and easier deformations of the matter (the Young module, rigidity characteristic, abrupt drop from T_{g}) (See [1]).

The PET chemical formula (See [1]) is as follows:

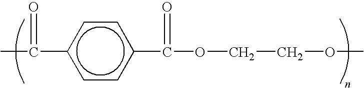

The crystallization of polymer occurs between the vitreous transition temperature T_{g} and the fusion temperature T_{f}. If the polymer is subjected to a deformation or a flowing, the kinetic of crystallization is accelerated. It is important to note that the crystalline texture obtained in this case is complex and anisotropic (See. [3]).

The energy contribution necessary to modify the structure of the macromolecular chains can be thermal (which is then referred to as natural or static crystallization), or mechanical, by permanent deformation of the material. This energy contribution by deformation exhibits the following advantages, among others:
It is fast (it induces the chains to stretch and to orientate, facilitating their transition from a disordered amorphous state to a crystallized structure),
the induced orientation increases the mechanical resistance of the material,
the crystals formed retain the translucence of the material, contrary to crystals generated by thermal crystallization (the lamellas formed remaining small in size in relation to the wave lengths or the visible spectrum)

In this crystallized and orientated state, the PET exhibit numerous qualities: very good mechanical properties (high rigidity, good resistance to traction and to tearing), good optical properties and barrier properties to CO₂. (See [2])

The mechanical properties of PET are essentially a function of the crystalline texture, the crystalline volumetric fraction and the molecular dimension and orientation. It is known that these parameters are particularly affected by the thermal history of the material (See [4]).

The long-term structural hardening of the polymer is exclusively associated with the crystallization; however, recent studies show that this hardening appears even without complete crystallization and can be attributed to the orientation of the macronuclear chains and their organization (See [5]).

These mechanical properties justify the use of PET in the stretch-blowing of containers, and particularly bottles. Stretch-blowing causes a bi-orientation of the polymer, that is, on the one hand, an axial orientation of the macromolecules at the time of the stretching by means of a stretch rod and, on the other hand, a radial orientation of the macromolecules at the time of the blowing.

More precisely, the stretching of the PET causes a warped or trans type change of conformation of the molecular chains, leading to a partial crystallization of the polymer. In microstructure terms, the benzenic cores tend to orient in a parallel plane to the main directions of the stretching. As we remarked above, the PET does not crystallize 100%, the maximum rate noted being about 50%. The containers manufactured within the industry and particularly bottles, generally exhibit a rate close to 35%. (See [2])

We will see here following, for certain particular operating applications, the rate of crystallinity can be increased (up to 40% and, some assert, even more than that (See [6])).

Several known methods make it possible to measure the crystallinity rate of a polymer. The two most prevalent methods are densimetry and differential calorimetric analysis (better known by its English acronym DSC—Differential Scanning Calorimetry). These methods are described in [2] and summarized here following.

Densimetry is based on the determination of the density of the material: when the material crystallizes, its density increases due to the compacter organization of the chains in the crystalline phase. Assuming that the specific volumes of the two phases follow a mixture law, one can then calculate the crystallinity rate by the following relationship:

$${X}_{c} = \frac{d}{{d}_{c}} \frac{{d}_{a} - d}{{d}_{a} - {d}_{c}}$$

The density d of the sample is measured by successive weighings in the air and in water. The density dₐ=1.333 g/cm³ of the amorphous phase is a relatively well-established value. The density d_{c} of the crystalline phase varies between 1.423 et 1.433 g/cm³ for an oriented PET having undergone a tempering between 60° C. and 100° C. The generally acceptable value is 1.455 g/cm³.

The DSC analysis itself consists of establishing a thermogram for the available polymer sample. Traditionally, this thermogram was traced by implementing a heating of the material at a speed of 10° C./min.

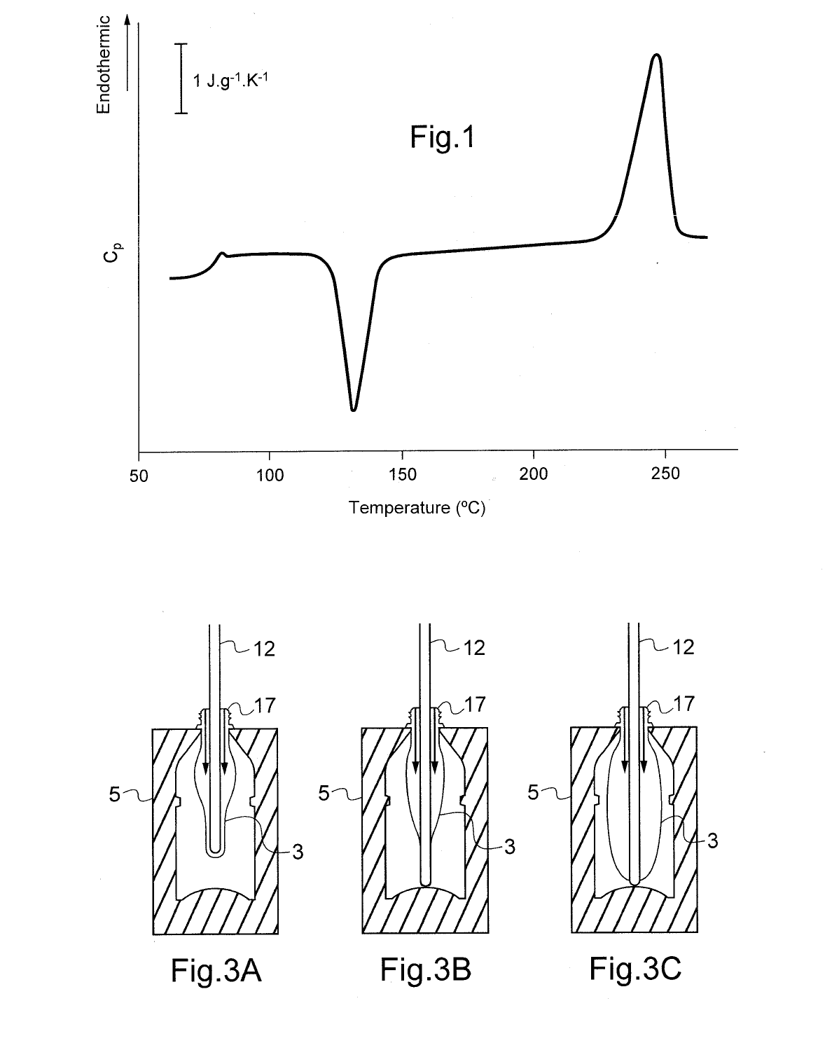

An example of a thermogram is reproduced on FIG. 1, for an industrial PET (PET 9921W EASTMAN), generally used for the stretch-blowing of bottles (See [3]) and the molecular mass of which is Mₙ=26 kg/mol. The evolution of the vitreous transition temperature (to T_{g}=78° C.) results in an inflexion of the curve. One then observes a first exothermic peak centered around 135° C., characteristic of the crystallization of the initially amorphous material (See [2]), then a second peak, endothermic this time, at T_{f}=250° C., corresponding to the fusion of the previously formed crystals.

The calculation of the initial crystallinity rate can be done by comparing the enthalpy difference (area under the peaks) between fusion and crystallization, that is noted ΔH, with the fusion enthalpy H_{ref} of a PET assumed to be perfectly crystalline, the value of which is generally chosen at around 100 J.g⁻¹. The crystallinity rate is given by the following equation:

$${X}_{c} = \frac{Δ H}{{H}_{ref}}$$

DSC analysis appears to be frequently preferred to densimetry, which is reputed to be less precise.

Context of the Invention

Having made these remarks, we will now focus on the context in which the invention was realized.

As we have seen, the crystallinity and the molecular orientation of the polymer have an affect on the mechanical properties. Manufacturers have long applied this knowledge in order to increase the rigidity of containers, for example in order to enable them to sustain significant pressures, possibly reaching several bars (case of carbonated drinks).

Numerous manufacturers have likewise sought to apply the supposed consequences of the crystallization of materials to the mechanical properties of the containers manufactured from these materials. In particular, it is universally asserted in scientific and technical literature that increasing the crystallinity reduces the shrinkage of the container during the hot filling of it, that is to say at a temperature greater than the vitreous transition temperature T_{g}. (The shrinkage is the result of the release of internal stresses accumulated by the material at the time of its macromolecular orientation during the stretch-blowing (See [7]).)

Increased crystallinity has customarily been obtained by a process known-as thermosetting (heat set in English), which consists, at the end of the blowing, of keeping the formed container against the wall of the mold, which is heated to a preset temperature that can range up to 250° C. The container is thus kept pinned flat against the wall of the mold for several seconds. There are numerous recommendations, varying from manufacturer to manufacturer, both with respect to the temperature and the duration of the thermo fixation. [8] and [9], specifically, propose a range of temperatures between 130° C. and 250° C. and times (6 sec, 30 sec and 120 sec), specifically intended to reduce the shrinkage of the container during a hot filling. The containers having undergone a thermosetting to make them resistant to deformation at the time of a hot-filling are, in current manufacturing language, called HR (heat resistant).

[6] proposes to circulate in the container, at the end of the blowing, a gas (of air) at a so-called high temperature between 200° C. and 400° C., so as to bring the inside wall of the container to a temperature of at least 120° C. in order to increase its crystallinity. It presumed in this document that the total duration of the manufacturing of the container can be less than 6 sec, while the crystallinity rate obtained varies from 34.4% to 46.7%. (It should be noted that it concerns average container crystallinity rates, measured by a densimetric method akin to that presented above.) According to [6], a crystallinity rate greater than 30% must be considered to be characteristic of a high crystallinity.

It has likewise been proposed (See [10]) to implement the blowing of the container in two stages: a first one during which an intermediate container of greater volume than the container to be obtained is formed, then a second during which the container is molded to its final dimensions. Between these two stages, the intermediate container is heated to a temperature between 180° C. and 220° C. for a period between 1 min and 15 min. According to [10], the variation of the volume of the container during its hot filling (i.e. at a temperature from 93° C. to 95° C.) is less than 5%, in these conditions. One explanation proposed is that the two successive molding operations provide two crystalline bioorientations, instead of a single one in the classical processes.

It has in addition been proposed (See [11]) to produce containers with a crystallinity on the inside greater than the crystallinity on the outside, in order to minimize the dispersion of the aromas of the liquid.

An analysis of the existing manufacturing techniques and particularly those that have just been briefly remarked upon, demonstrate that an essential concern, in the proposed solutions, is to find the maximum crystallinity for the final container, so as to reduce its shrinkage as much as possible when it is hot filled. Manufacturers run up against a recurrent problem—the contradiction between the crystallinity rate (which they want to maximize, as we have just seen) and the cycle time (which they want to minimize). It is in fact currently accepted that the crystallization of the polymer becomes easier as the deformation speed decreases (See [1] in particular). The cycle times presented in the cited documents are relatively long (greater 5 sec., some exceeding one minute) and necessitating multiple machines to meet current requirements in terms of rates (up to 50,000 containers per hour), which puts a burden on production costs.

Presentation of the Invention

The invention seeks to propose a container exhibiting improved performances at the time of a hot filling.

To do so, the invention proposes a polymer container, having an inside wall and an opposed outside wall, the crystallinity rates of which exhibit a negative gradient on the side of the inside wall.

According to one embodiment, the crystallinity rate of the side of the inside wall is less than or equal to 25%.

With respect to the crystallinity of the side of the outside wall, it is preferably greater than or equal to 30%.

The crystallinity rate of the side of the inside wall is preferably less, from about 20% to 50% of the crystallinity rate of the side of the outside wall.

According to one embodiment, the inside wall exhibits a thickness less than about 100 μm, and for example less than about 50 μm.

The container can be thermoset; moreover, the inside wall can exhibit, on a DSC curve, an exothermic peak between the vitreous transition temperature and a fusion peak.

Other uses and advantages of the invention will appear in the light of the following description in reference to the drawings attached in which:

FIG. 1 is a differential calorimetric analysis (DSC) thermogram illustrating the thermal capacity variations of an initially amorphous PET;

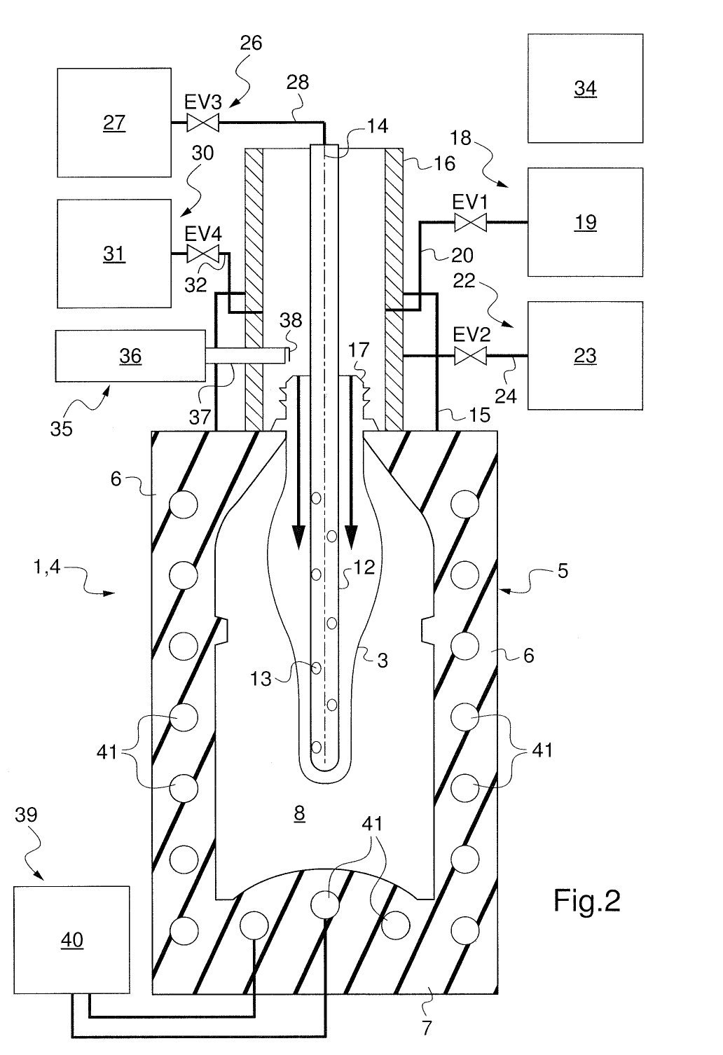

FIG. 2 is a schematic view of a cross-section elevation view showing a machine for manufacturing containers by stretch-blowing;

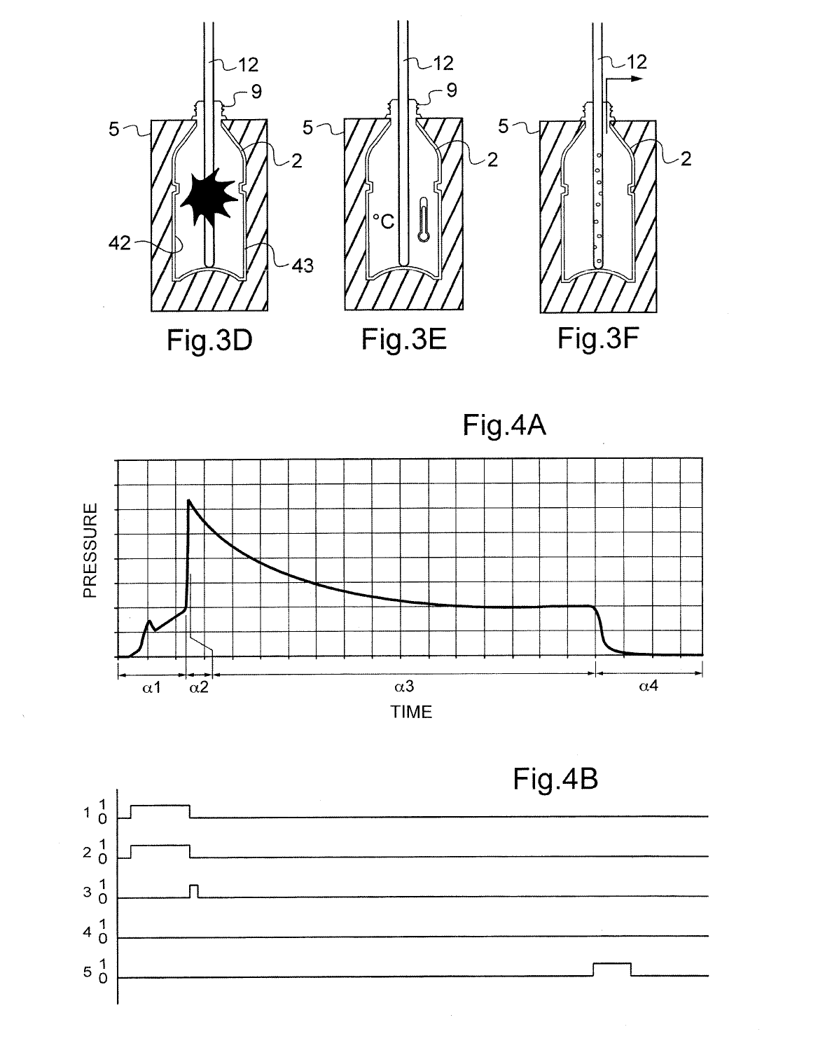

FIGS. 3A to 3F are schematic cross-section elevation views showing different successive stages of a manufacturing process by stretch-blowing of containers, according to a first example of execution;

FIG. 4A is a graph illustrating the evolution over time of the pressure prevailing in the container at the time of its stretch-blowing in accordance with the process illustrated on FIGS. 3A to 3F;

FIG. 4B is a chronogram illustrating the opening and closing of the electromagnetic valves as well as the ignition operation within the machine illustrated on FIG. 2, for the implementation of the process illustrated on FIGS. 3A to 3F and on FIG. 4A;

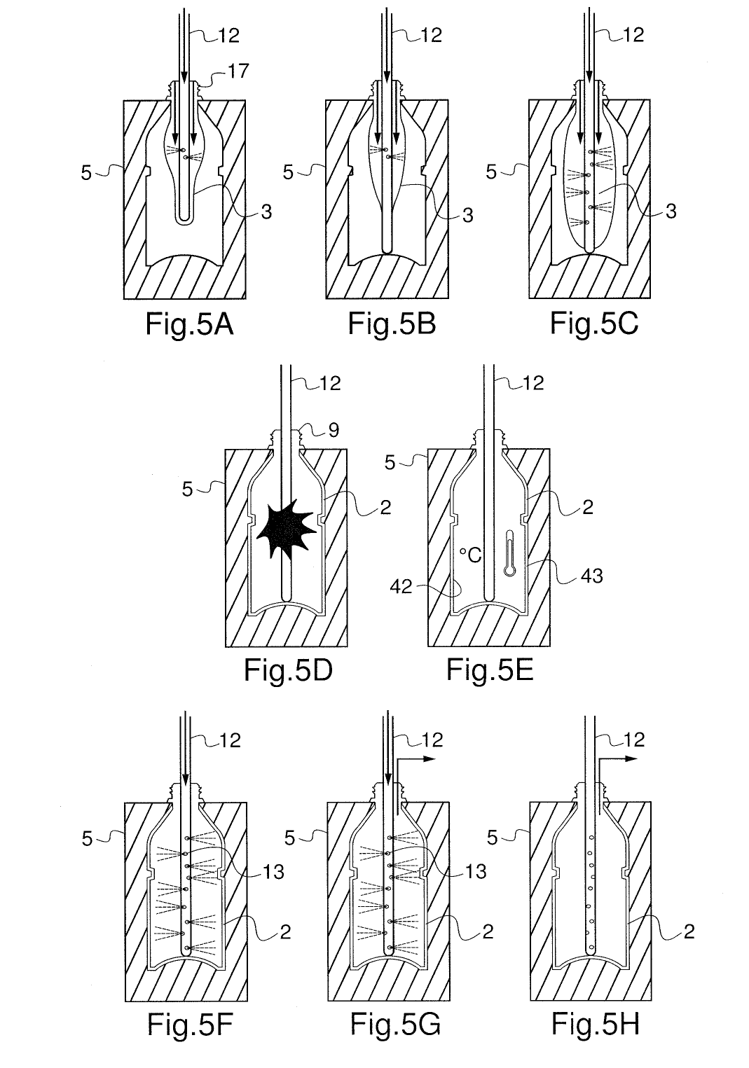

FIGS. 5A to 5H are schematic cross-section elevation views showing various successive stages of a manufacturing process by stretch-blowing of containers, according to a second example of execution;

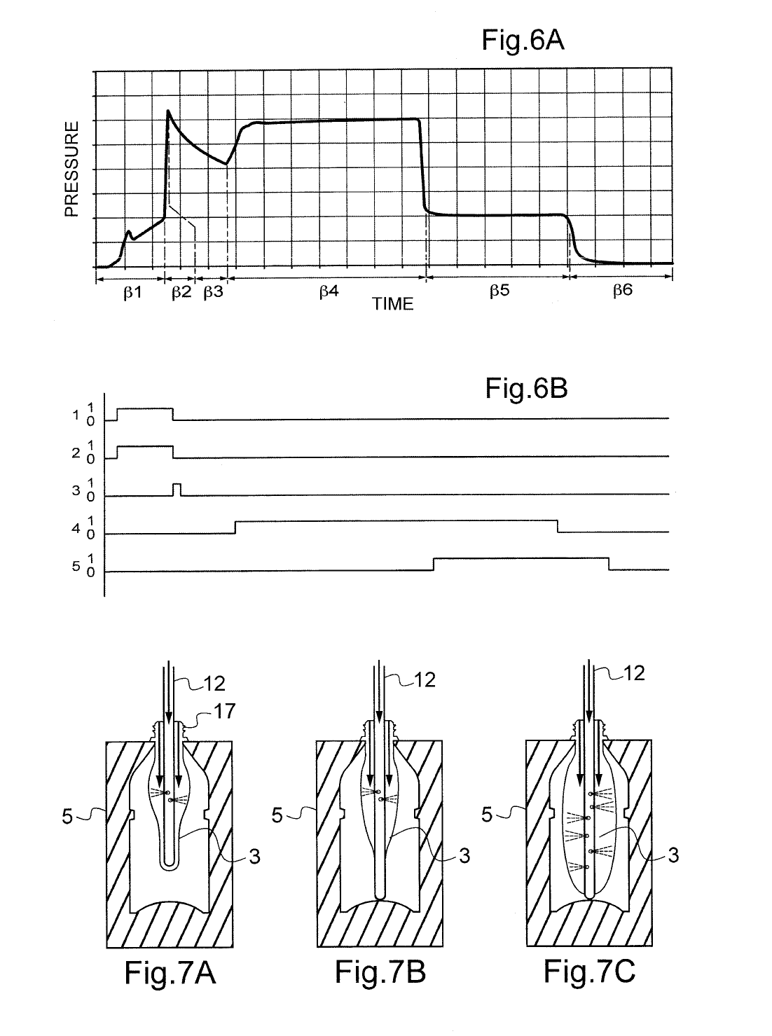

FIG. 6A is a graph illustrating the evolution over time of the pressure prevailing in the container at the time of its stretch-blowing in accordance with the process illustrated on FIGS. 5A to 5F;

FIG. 6B is a chronogram illustrating the opening and closing of the electromagnetic valves as well as the ignition operation within the machine illustrated on FIG. 2, for the implementation of the process illustrated on FIGS. 5A to 5H and on FIG. 6A;

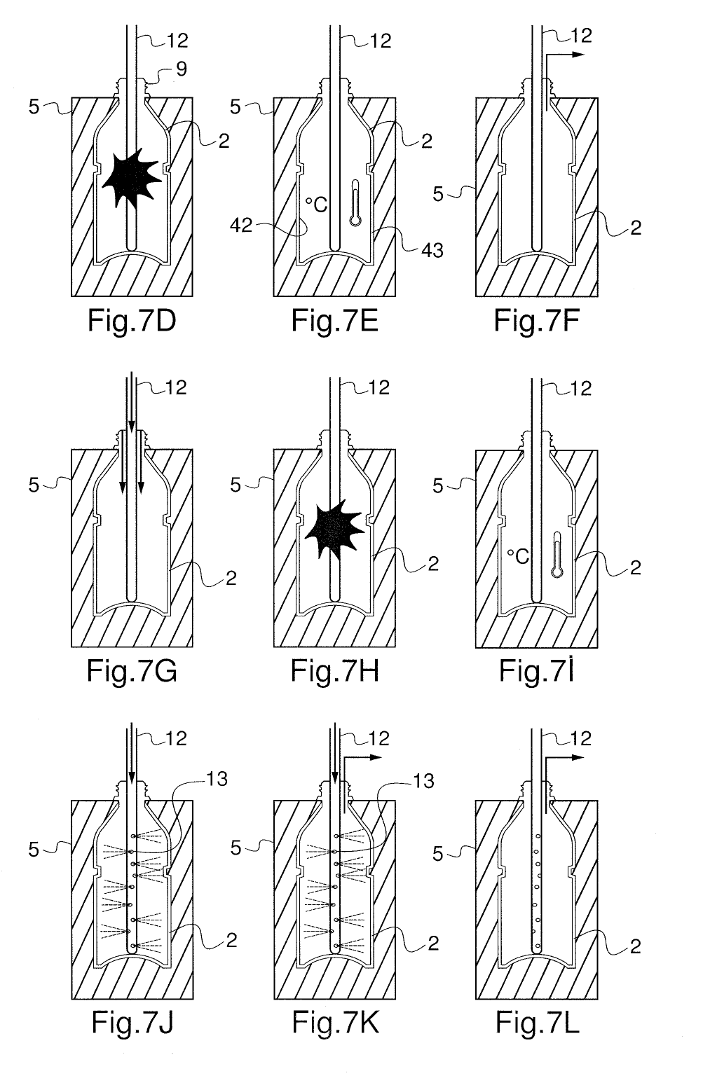

FIGS. 7A to 7L are schematic cross-section elevation views showing different successive stages of a manufacturing process by stretch-blowing of containers, according to a third example of execution;

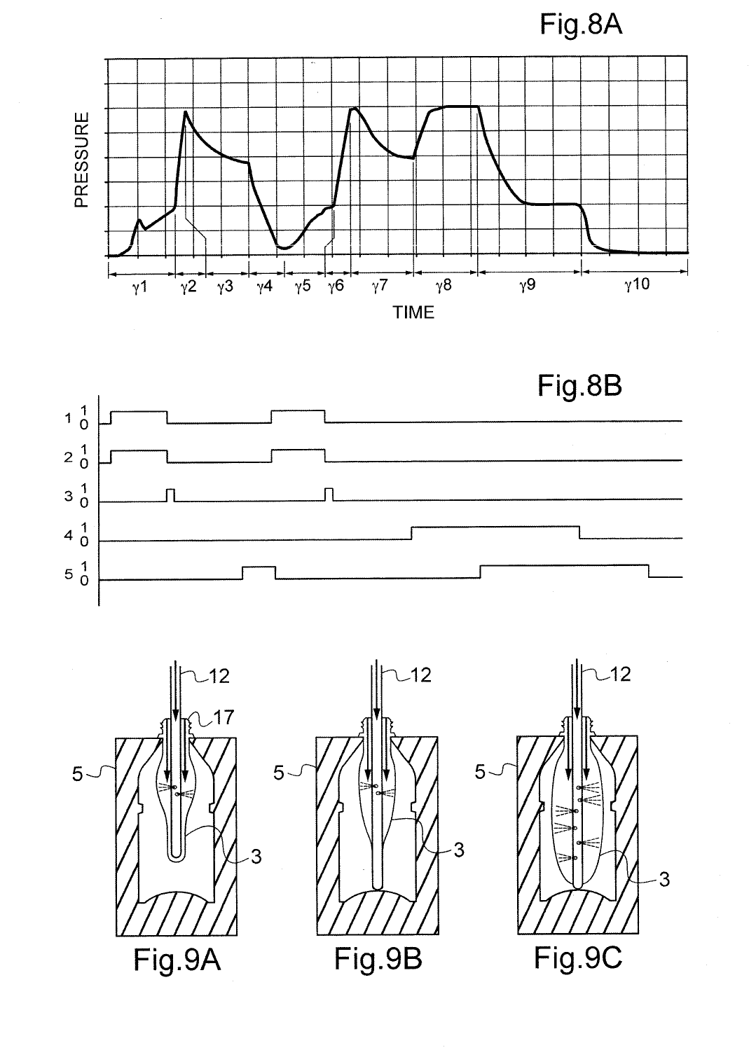

FIG. 8A is a graph illustrating the evolution over time of the pressure prevailing in the container at the time of its stretch-blowing in accordance with the process illustrated on FIGS. 7A to 7L;

FIG. 8B is a chronogram illustrating the opening and closing of the electromagnetic valves as well as the ignition operation within the machine illustrated on FIG. 2, for the implementation of the process illustrated on FIGS. 7A to 7L and on FIG. 8A;

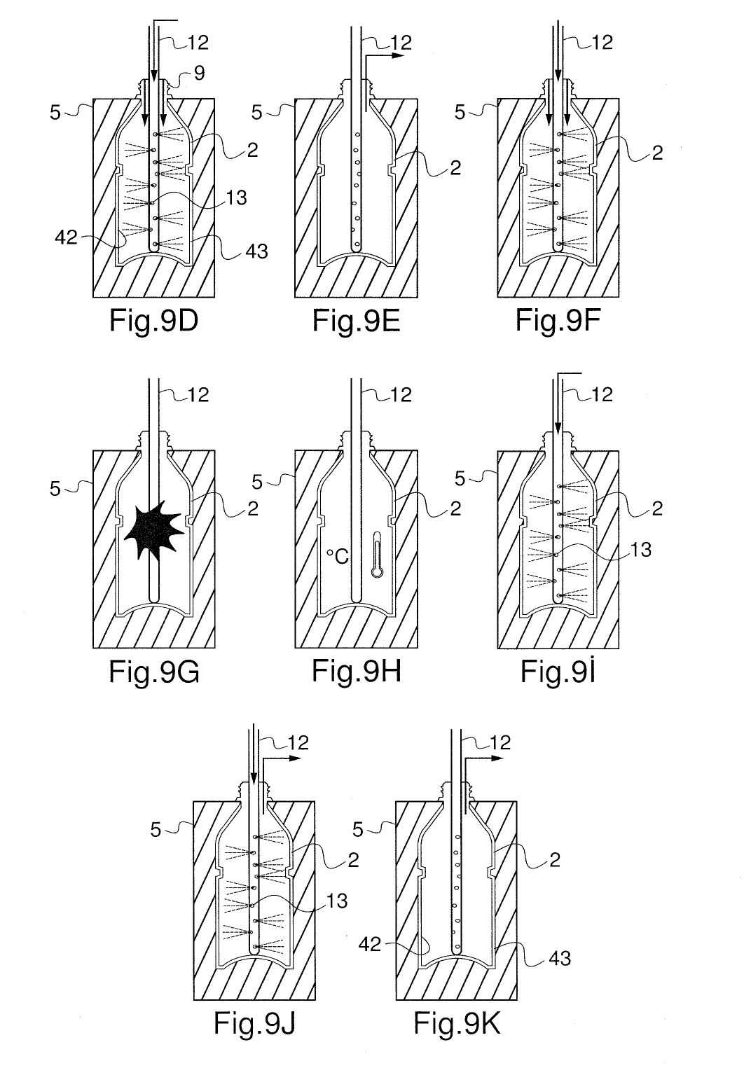

FIGS. 9A to 9K are schematic cross-section elevation views showing various successive stages of a manufacturing process by stretch-blowing of containers, according to a fourth example of execution;

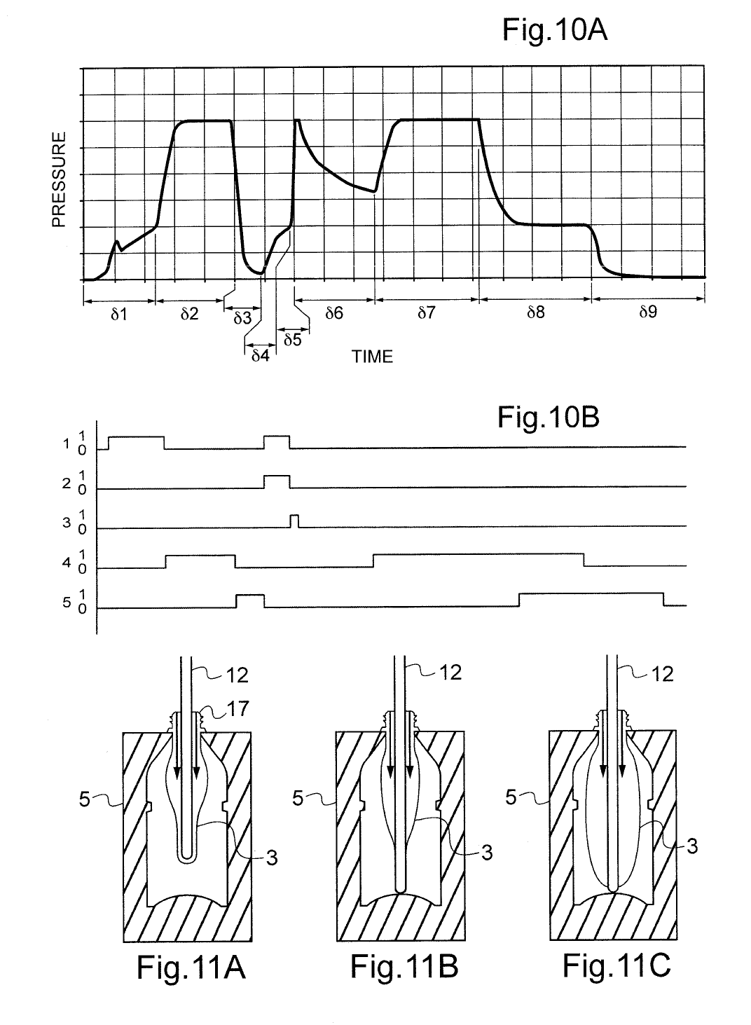

FIG. 10A is a graph illustrating the evolution over time of the pressure prevailing in the container at the time of its stretch-blowing in accordance with the process illustrated on FIGS. 9A to 9K;

FIG. 10B is a chronogram illustrating the opening and closing of the electromagnetic valves as well as the ignition operation within the machine illustrated on FIG. 2, for the implementation of the process illustrated on FIGS. 9A to 9K and on FIG. 10A;

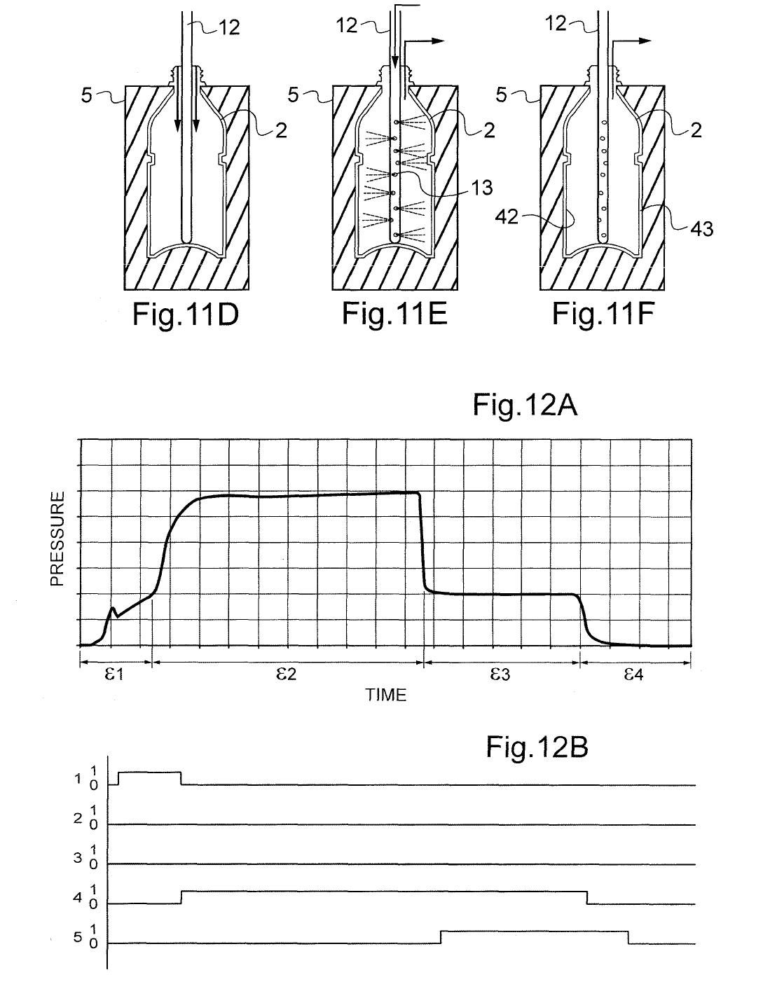

FIGS. 11A to 11F are schematic cross-section elevation views showing different successive stages of a manufacturing process by stretch-blowing of containers, according to a fifth example of execution;

FIG. 12A is a graph illustrating the evolution over time of the pressure prevailing in the container at the time of its stretch-blowing in accordance with the process illustrated on FIGS. 11A to 11F;

FIG. 12B is a chronogram illustrating the opening and closing of the electromagnetic valves of a machine implementing the process illustrated on FIG. 12A;

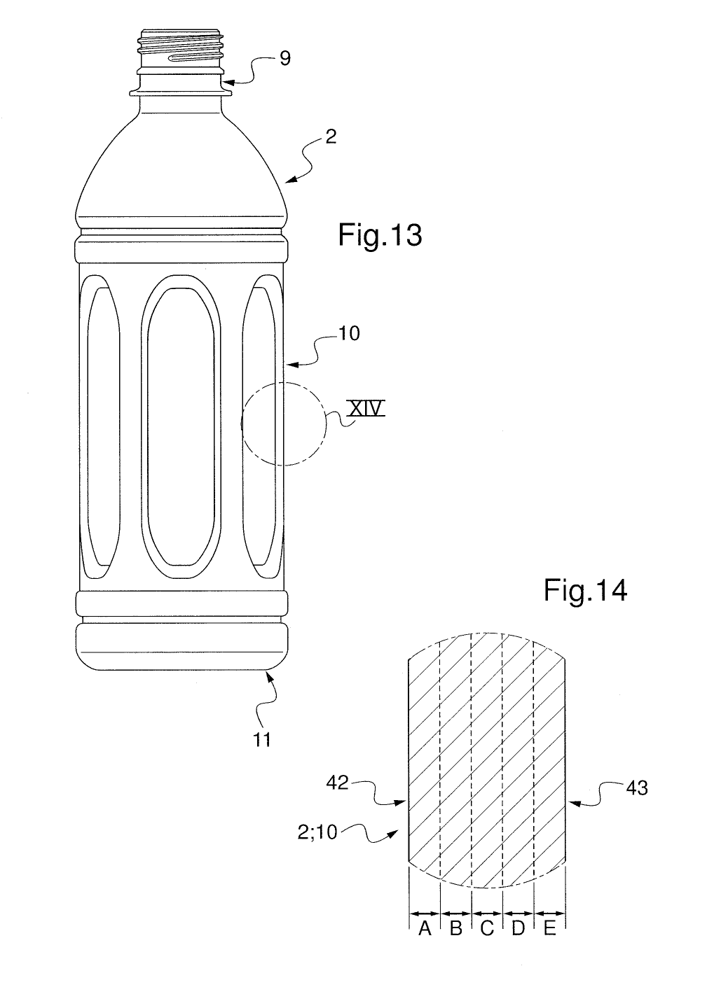

FIG. 13 is a top view showing a typical example of a container obtained by a manufacturing process according to any one of the examples illustrated on the preceding figures;

FIG. 14 is an enlarged scale sectional view of a detail of the body of the container of FIG. 13, taken in the inset XIV;

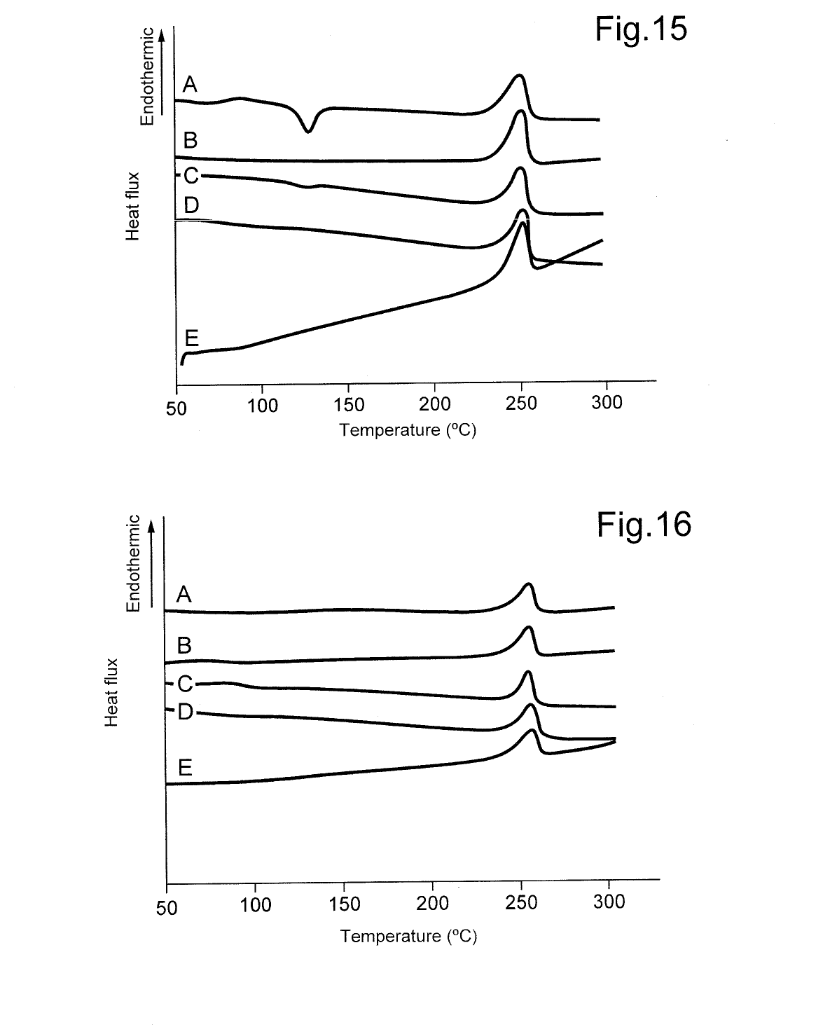

FIG. 15 is a thermogram of differential calorimetric analysis (DSC) illustrating the variations of the mass thermal capacity of a container manufactured according to a manufacturing process according to one of the examples illustrated in the preceding figures, for five successive sections of the wall of the container; and

FIG. 16 is thermogram similar to that of FIG. 14, for a container manufactured according to a manufacturing process according to another of the examples illustrated in the preceding figures.

FIG. 2 partially illustrates a machine 1 for manufacturing containers 2 by stretch-blowing from polymer blanks 3. Here following, the blanks 3 are the preforms: this term is used for purposes of consistency.

Machine 1 comprises a plurality of molding units 4, mounted on a carousel (not shown), each comprising one mold 5 (as illustrated in FIG. 2). This mold 5, made of steel or aluminum alloy, comprises two die halves 6 and a mold base 7 that together define an internal cavity 8, intended to receive a preform 3 previously heated to a temperature greater than the vitreous transition temperature (Tg) of the matter comprising the preform 3, the shape of which corresponds to the final desired shape of the container 2 manufactured from this preform 3. Whatever its shape, container 2 (as illustrated in FIG. 13) generally comprises a neck 9, a body 10 and a bottom 11.

The molding unit 4 comprises:
a stretch rod 12 equipped with holes 13 and mounted sliding in relation to the mold 5 along the main axis 14 (generally revolving) thereof, between an upper position permitting the introduction of the perform 3 and a lower position where, at the end of the stretching of the preform 3, the rod 12 reaches the bottom of the mold 7, pinning it flat on the bottom of it 11,
a casing 15 defining a nozzle 16 into which the rod 12 slides and which, at the time of the manufacture of the container 2, engages with a neck 17 of the preform 3 (joined with the neck 9 of the container and not sustaining deformation during the manufacture),
several fluidic circuits run into the nozzle 16 via casing 15, that is:
a medium pressure pre-blowing air circuit 18 (between 5 and 20 bars), this circuit 18 comprising a pre-blowing air source 19 (for example a first compressed air line supplying several machines) and a conduit 20 (that can be established at least partially in the casing 15) connecting this source 19 to the nozzle 16 with the interposition of a first electromagnetic valve EV1,
a reactive gas circuit 22 (gas examples will be given here following) comprising a reactive gas source 23 and a conduit 24 (which can be formed at least partially in the casing 15) connecting this source 23 to the nozzle 16 with the interposition of a second electromagnetic valve EV2,
a high pressure blowing air circuit 26 (between 30 and 40 bar), comprising a blowing air source 27 (for example a second compressed air line supplying several machines) and a conduit 28 (that can be established at least partially in the casing 15 connecting this source 27 to the rod 12 with the interposition of a third electromagnetic valve EV3,
a degassing circuit 30 comprising a vent orifice 31 (possibly doubled from a pump) and a conduit 32 connecting the nozzle to this orifice with the interposition of a fourth electromagnetic valve EV4.

The reactive gases can be hydrogen (H₂), methane (CH₄), propane (C₃H₈) or acetylene (C₂H₂).

Hydrogen is preferred due to the non-polluting character of its oxidation reaction (2H₂+O_{2→}2H₂O), the product of which is pure water. Hydrogen can either be produced on demand, directly upstream of the machine 1 (for example by electrolysis of the water), or stored in containers from where it is drawn for the needs of the process.

The conduits 20, 24, 28, 32 can be established at least partially in the casing 15, as is illustrated in FIG. 2. As for the electromagnetic valves EV1, EV2, EV3, EV4, they are connected electrically to a control unit 34 that controls the opening and closing of them (duly taking into account the response time of the electromagnetic valves). These electromagnetic valves EV1, EV2, EV3, EV4 can be arranged at a distance from the casing 15 or, integrated within it for greater compactness. To make such a casing 15, a person skilled in the art could refer to patent application FR 2 872 082 (Sidel) or to the equivalent international patent application WO 2006/008380.

The state of electromagnetic valves EV1, EV2, EV3, EV4 (closed/open) and of the spark plug 36 (out/lit) is illustrated in the chronograms of FIGS. 4B, 6B, 8B, 10B, 12B, each consisting of five lines, numbered 1 to 5 and respectively representing:
line 1, the state (0: closed/1: open) of the first electromagnetic valve (pre-blowing air supply),
line 2, the state (0: closed/1: open) of the second electromagnetic valve (reactive gas supply),
line 3, the state (0: out/1: lit) of the spark plug,
line 4, the state (0: closed/1: open) of the third electromagnetic valve (blowing air supply),
line 5: the state (0: closed/1: open) of the fourth electromagnetic valve (degassing).

As seen in FIG. 2, the molding unit 4 is in addition equipped with a device for its own ignition 35, at a pre-set given instant and actuated by the control unit 34, to produce within nozzle 16 (or of the container 2) a spark for igniting the air and reactive gas mixture in the container 2.

According to an embodiment, this ignition device 35 comprises a spark plug 36 having a center electrode 37 and an earth electrode 38 both leading into nozzle 16 (that communicates with the inside of the container 2)—or, as a variant, in the rod 12—and between which, upon actuation by control unit 34, an electrical arc can be produced, causing the ignition of the mixture.

As illustrated in FIG. 2, molding unit 4 is in addition equipped with a circuit 39 for heating mold 5, comprising a pressurized coolant source 40 (by oil or water, for example) and conduits 41 arranged in the thickness of the mold 5 (half dies 6 and bottom 7 included), in which the coolant fluid coming from source 40 circulates to keep mold 5 at a temperature above the ambient temperature (20° C.). In practice, the temperature of the mold is regulated at an average value between 20° C. and 160° C. (measured on the inside wall of mold 5), depending on the applications—examples of temperatures are provided here following.

Here following are described five specific examples of manufacturing processes for containers 2 of the HR (heat resistant) type having for example a shape such as that illustrated in FIG. 13, by means of machine 1, which has just been described.

For each example described, DSC is used to measure the crystallinity of a container 2 obtained by the corresponding process. More precisely, the crystallinity of body 10 of container 2 is measured, at least on the side of an inside wall 42 and an outside wall 43. For this purpose a sample is taken in the body 10 and is cut (by microtomic cutting, for example) into serial segments at its thickness, the respective crystallinity of which is then measured. According to one embodiment, the sample is cut into five approximately equal segments. For example, for a container 2, the thickness of which is approximately 360 μm, each cut segment exhibits a thickness of 50 μm (the cutting blade forming, with each pass between two successive segments, shavings of a thickness of approximately 25 μm). A, B, C, D and E show the five successive segments of material, from the insider of container 2.

We would like to point out that the DSC analysis makes it possible to quantify the thermal phenomena (endo or exothermic) accompanying the transformations crystallization, fusion) of a material.

The procedure used here is as follows.

A differential micro calorimeter with power compensation is used. Such a micro calorimeter includes two ovens under a neutral atmosphere (generally in nitrogen). A reference is placed into the first (generally an empty cup). The sample on which the DSC measurements are to be made is placed into the second.

Each oven is equipped with two platinum resistances, one of which serves for the heating and the other for measuring the temperature.

The heat fluxes exchanged are measured, on the one hand between the reference and the outside medium, and on the other hand between the sample and the outside medium as the temperatures is increased at a constant heating velocity from the ambient temperature (about 20° C.) up to a temperature greater than the known fusion temperature of the studied material (in this case, for the PET it is heated up to about 300° C., it being assumed that the material fuses at approximately 250° C.).

The mass thermal capacity is deduced from the studied sample by comparison with the reference, by the following relationship:

$${C}_{p} = \frac{1}{m} \frac{d Q}{d T}$$

Where:

m is the mass of the sample in grams,

T the temperature,

Q the amount of heat in J.g⁻¹.K⁻¹ necessary to cause an increase of the temperature in the sample of the value dT.

If the heating velocity q is introduced, kept constant at the time of the measurement (and in the selected case equal to 10 K⁻¹), defined by the relationship

$$q = \frac{d Q}{d t} ,$$

then the mass thermal capacity can be written as follows:

$${C}_{p} = \frac{1}{m \cdot q} \frac{d Q}{d T}$$

The variations of the mass thermal capacity of the sample in relation to the temperature are traced from the measurements of the heat flux performed in the micro calorimeter. The curve of these variations is called a thermogram. Such a thermogram is shown in FIG. 1 for a sample of the PET of the manufacturer EASTMANN mentioned in the introduction.

Such a thermogram makes it possible to differentiate the exothermic phenomena (oriented downwards) from the endothermic phenomena (oriented upwards).

For any initially amorphous PET sample, such as the above sample mentioned, one finds two peaks—a first exothermic peak (in this case around 135° C.), corresponding to the crystallization of the material and an endothermic peak (in this case around 250° C.) corresponding to the fusion of the material.

The rate of crystallinity of the initial material can be calculated from the thermogram, from the difference ΔH of the enthalpies exchanged during the fusion phenomena on the one hand and the crystallization on the other.

The fusion enthalpy ΔH_{f} is defined by the area under the fusion peak:

$$Δ {H}_{f} = {\int }_{pic fusion} {C}_{p} ( T ) d T$$

The crystallization enthalpy ΔH_{c} is itself defined by the area under the crystallization peak:

$$Δ {H}_{c} = - {\int }_{pic cristallisation} {C}_{p} ( T ) d T$$

The differences of the fusion and the crystallization enthalpy are deduced from: ΔH=ΔH_{f}−ΔH_{c}, then the crystallinity rate from the following relationship:

$${X}_{c} = \frac{Δ H}{{H}_{ref}}$$

Where H_{ref} is the enthalpy of fusion of a presumed completely crystalline sample. Here a value of 140 J.g⁻¹ is selected, which corresponds to the value most commonly used in plastic materials laboratories.

### EXAMPLE 1

### FIGS. 3A to 3F, 4A and 4B

In this example, the mold 5 is heated such that such that it exhibits on the surface of its inside wall a temperature of approximately 160° C. The material of the preform 3 is a PET. The reactive gas is hydrogen (H₂). The air/hydrogen gaseous mixture is made by complying with a hydrogen proportion by volume between 4% and 18%, preferably 6%.

Following introduction of the hot preform 3 into the mold 5, the process comprises a first operation, known as pre-blowing, consisting of stretching preform 3 by sliding rod 12 and simultaneously opening the electromagnetic valves EV1 and EV2 to introduce into the preform 3 an air and reactive gas mixture at a pressure between approximately 5 and 20 bars (FIGS. 3A to 3C, lines 1 and 2 on FIG. 4B). This first operation of a predetermined durational (less than 250 ms) ends by the closing of the electromagnetic valves EV1 and EV2 after rod 12 has ended its travel having reached the bottom of mold 7 and the threshold for the plastic outflow of the material has been exceeded (which is indicated on the pressure curve by a first pressure peak, at approximately 8 to 10 bars).

A second operation, known as ignition, consists of igniting the gaseous mixture by ignition of spark plug 36 (FIG. 3D, line 3 in FIG. 4B). Taking into account the proportion of hydrogen in the gaseous mix, an explosion occurs in container 2 that is being formed, which is accompanied by a sudden increase of the temperature (which reaches hundreds of degrees Celsius) and of the pressure (which exceeds 40 bars—on the curve of FIG. 4A; the corresponding peak pressure is clipped due to reasons of scale). The duration of the α2 of the ignition of the mixture is extremely brief (less than 25 ms), but the increased pressure that accompanies it is sufficient to pin the substance flat against the wall of the mold, thus forming container 2.

A third operation, known as stabilization, consists of maintaining in container 2 a residual gas (essentially a mixture of water vapor coming from the combustion of hydrogen, with possible traces of NO_{N}), for a predetermined duration α3 (between 1000 and 1500 ms) while keeping all the electromagnetic valves EV1, EV2, EV3, EV4 closed, so as to permit the reduction of the temperature and the pressure in container 2 (FIG. 3E).

A fourth operation, known as degassing, consists of degassing the container 2, by closing the third electromagnetic valve EV3 (FIG. 4B, line 4) and leaving open the fourth electromagnetic valve EV4 for a preset duration α4 (between 100 and 500 ms), to allow the air to escape (FIG. 3F) until the pressure prevailing inside container 2 has attained approximately the atmospheric pressure (FIG. 4B, line 5). At the end of this operation, the fourth electromagnetic valve EV4 is closed, the mold 5 opened and container 2 removed to enable repetition of the cycle with a new preform 3.

DSC was used, in the above described conditions, to measure the crystallinity of a container 2 obtained by this process, from the surface of inside wall 42 of the body 10 (segment A) and of the surface of its outside wall 43 (segment E). The results of the measurements are presented in the following table:

| Segment | Crystallinity (%) |
|---|---|
| A (inside wall) | 22 |
| E (outside wall) | 32 |

It is apparent that container 2 exhibits a negative gradient of crystallinity in the area of its inside wall 42. The crystallinity measured from the surface of the inside wall 42 is in this case much less (about 30%) than the crystallinity measured from the surface of the outside wall 43.

It may also be noted that the mechanical resistance to deformation of such a container 2, at the time of a hot filling (with a liquid, the temperature of which is between 85° C. and 95° C.), is greater than that of a container obtained by a process without ignition (See the comparative example). In fact, for a liquid temperature between 85° C. and 95° C., the retraction rate of the container is less than or equal to 1%.

This phenomenon can be explained as follows. The extreme temperature conditions (that reach several hundred degrees Celsius) and the pressure prevailing within container 2 over the course of the formation at the time of the explosion induced by the ignition of the explosive gaseous mixture cause the fusion of the material at least at the surface of the inside wall 42 of container 2.

Following the explosion, the formed container 2 undergoes a thermosetting, on the surface of its outside wall 43 in contact with the heated wall of mold 5. It thus benefits, over a certain thickness from its outside wall 43, from a contribution of crystallinity by thermal means, while its inside wall 42, which becomes completely (or almost) amorphous following its fusion, retains a high proportion of amorphous matter, with a comparatively lower rate of crystallinity.

Despite the low rate of crystallinity of the surface of the inside wall 42, the high rate of crystallinity of the surface of outside wall 43 gives the container 2 a rigidity equivalent to that of a container with constant crystallinity (such as a simply thermoset container, obtained by the process described in the comparative example, that is to say without igniting an explosive gaseous mixture), the portion of high crystallinity matter (comprising the outside wall 43) acting in the manner of a brace with respect to the portion of low crystallinity matter (comprising the inside wall 42).

In this example, the thickness of inside wall 42 corresponds to the thickness of the segment A as cut out for the needs of the DSC analysis (See above). The measurements have shown that the crystallinity gradient did not extend beyond segment C. Consequently, the inside wall 42 affected by the negative crystallinity gradient exhibits a thickness less than 100 μm and more likely less than approximately 50 μm.

During the hot filling, the residual stresses stored by the container 2 at the time of its formation are largely released into the amorphous matter present in a large proportion of the side of inside wall 42, which thus acts as a buffer in relation to the portion of high crystallinity matter, preventing the propagation of deformations in the container.

### EXAMPLE 2

### FIGS. 5A to 5H, 6A and 6B

In this example, the mold 5 is heated such that such that it exhibits on the surface of its inside wall a temperature of approximately 160° C. The material of the preform 3 is a PET. The reactive gas is hydrogen (H₂). The air/hydrogen gaseous mixture is made by complying with a hydrogen proportion by volume between 4% and 18%, preferably 6%.

Following introduction of the hot preform 3 into mold 5, a first pre-blowing operation, consisting of stretching preform 3 by sliding rod 12, and to simultaneously pre-blow it by opening the electromagnetic valves EV1 and EV2 to introduce into preform 3 an air and reactive gas mixture at a pressure between approximately 5 and 20 bars (FIGS. 5A to 5C, lines 1 and 2 on FIG. 6B). This first operation of a predetermined duration β1 (less than 250 ms) ends by the closing of the electromagnetic valves EV1 and EV2 after rod 12 has ended its travel having reached the bottom of mold 7 and the threshold for the plastic outflow of the material has been exceeded (which is indicated on the pressure curve by a first pressure peak, at approximately 8 to 10 bars).

A second operation, known as ignition, consists of igniting the gaseous mixture by ignition of spark plug 36 (FIG. 5D, line 3 in FIG. 6B). Taking into account the proportion of hydrogen in the gaseous mix, an explosion occurs in the container 2 that is being formed, which is accompanied by an abrupt increase of the temperature (which reaches hundreds of degrees Celsius) and of the pressure (which exceeds 40 bars—on the curve of FIG. 6A; the corresponding peak pressure is clipped due to reasons of scale). The duration β2 of the ignition of the mixture is extremely brief (less than 25 ms), but the increased pressure that accompanies it is sufficient to pin the matter flat against the wall of mold 5, thus forming the container 2.

A third operation, known as stabilization, consists of maintaining in container 2 the residual gas (essentially a mixture of water vapor coming from the combustion of hydrogen, with possible traces of NO_{X}), for a predetermined duration β3 (between 200 and 300 ms) while keeping all the electromagnetic valves EV1, EV2, EV3, EV4 closed, so as to permit the reduction of the temperature and the pressure in container 2 (FIG. 5E).

A fourth operation, known as blowing, consists of opening third electromagnetic valve EV3 to introduce into container 2, via holes 13 arranged in rod 12, high pressure air (between approximately 30 and 40 bars) at ambient temperature and thus keep pinned flat against the wall of mold 5 container 2 formed at the time of the ignition operation (FIG. 5F, line 4 on FIG. 6B). During this blowing operation, of a predetermined duration β4 (preferably less than 1000 ms), the fourth electromagnetic valve EV4 is kept closed.

A fifth operation, known as sweeping, consists of making an air sweep of container 2, while keeping third electromagnetic valve EV3 open to continue introducing high pressure air (FIG. 6B, line 4) at ambient temperature into container 2, while simultaneously opening fourth electromagnetic valve EV4 to permit pressurized air to be evacuated (FIG. 6B, line 5). An air circulation is thus generated in container 2 while maintaining it under pressure (between 10 and 15 bars), which continues to pin it flat against the wall of mold 5 while cooling it (at least on the surface of its inside wall 42), so that upon emerging from the mold 5 it retains the shape that the latter gives it (FIG. 5G). This sweep operation is performed for a predetermined duration β5, between 200 et 2000 ms.

A fourth operation, known as degassing, consists of degassing container 2, by closing the third electromagnetic valve EV3 (FIG. 4B, line 4) and leaving open the fourth electromagnetic valve EV4 for a preset duration β6 (between 100 and 500 ms), to allow the air to escape (FIG. 5H) until the pressure prevailing inside container 2 has attained about the atmospheric pressure (FIG. 6B, line 5). At the end of this operation, the fourth electromagnetic valve EV4 is closed, the mold 5 opened and the container 2 removed to enable repetition of the cycle with a new preform 3.

DSC was used, in the above described conditions, to measure the crystallinity of a container 2 obtained by this process, from the surface of inside wall 42 of the body 10 (segment A) and of the surface of its outside wall 43 (segment E). The results of the measurements are presented in the following table:

| Segment | Crystallinity (%) |
|---|---|
| A (inside wall) | 22 |
| E (outside wall) | 32 |

It is noted that container 2 exhibits a negative gradient of crystallinity in the area of its inside wall 42. The crystallinity measured from the surface of the inside wall 42 is in this case much less (about 30%) than the crystallinity measured from the surface of the outside wall 43.

It may also be noted that the mechanical resistance to deformation of such a container 2, at the time of a hot filling (with a liquid, the temperature of which is between 85° C. and 95° C.), is greater than that of a container obtained by a process without ignition (See the comparative example). In fact, for a liquid temperature between 85° C. and 95° C., the retraction rate of the container is less than or equal to 1%.

This phenomenon can be explained as follows. The extreme temperature conditions (that reach several hundred degrees Celsius) and the pressure prevailing within container 2 over the course of the formation at the time of the explosion induced by the ignition of the explosive gaseous mixture cause the fusion of the material at least at the surface of the inside wall 42 of container 2.

Following the explosion, formed container 2 undergoes a thermosetting, from the side of its outside wall 43 in contact with the heated wall of mold 5. It thus benefits, over a certain thickness of its outside wall 43, from a contribution of crystallinity by thermal means, while its inside wall 42, which becomes completely (or almost completely) amorphous following its fusion, retains a high proportion of amorphous matter, with a comparatively lower rate of crystallinity.

Despite the low rate of crystallinity of the surface of the inside wall 42, the high rate of crystallinity of the surface of outside wall 43 gives the container 2 a rigidity equivalent to that of a container with constant crystallinity (such as a simply thermoset container, obtained by the process described in the comparative example, that is to say without igniting an explosive gaseous mixture), the portion of high crystallinity matter (comprising the outside wall 43) acting in the manner of a brace with respect to the portion of low crystallinity matter (comprising the inside wall 42).

In this example, the thickness of inside wall 42 corresponds to the thickness of the segment A as cut out for the needs of the DSC analysis (See above). The measurements have shown that the crystallinity gradient did not extend beyond segment C. Consequently, the inside wall 42 affected by the negative crystallinity gradient exhibits a thickness less than 100 μm and more likely less than approximately 50 μm.

During the hot filling, the residual stresses stored by the container 2 at the time of its formation are largely released into the amorphous matter present in a large proportion of the side of inside wall 42, which thus acts as a buffer in relation to the portion of high crystallinity matter, preventing the propagation of deformations in the container.

### EXAMPLE 3

### FIGS. 7A to 7L, 8A and 8B

In this example mold 5 is heated such that it exhibits on the side of its inside wall a temperature of approximately 130° C. The material of the preform 3 is a PET. The reactive gas is hydrogen (H₂). The air/hydrogen gaseous mixture is made by complying with a hydrogen proportion by volume between 4% and 18%, preferably 6%.

Following introduction of the hot preform 3 into mold 5, a first operation, known as pre-blowing, consists of stretching preform 3 by sliding rod 12 and simultaneously pre-blowing it by opening electromagnetic valves EV1 and EV2 to introduce into preform 3 an air and reactive gas mixture at a pressure between approximately 5 and 20 bars (FIGS. 7A to 7C, lines 1 and 2 on FIG. 8B). This first operation of a predetermined duration γ1 (less than 250 ms) ends by the closing of the electromagnetic valves EV1 and EV2 after rod 12 has ended its travel having reached the bottom of mold 7 and the threshold for the plastic outflow of the material has been exceeded (which is indicated on the pressure curve by a first pressure peak, at approximately 8 to 10 bars).

A second operation, known as primary ignition, consists of igniting the gaseous mixture by ignition of spark plug 36 (FIG. 7D, line 3 in FIG. 8B). Taking into account the proportion of hydrogen in the gaseous mix, an explosion occurs in the container 2 that is being formed, which is accompanied by an abrupt increase of the temperature (which reaches hundreds of degrees Celsius) and of the pressure (which exceeds 40 bars—on the curve of FIG. 7A; the corresponding peak pressure is clipped due to reasons of scale). The duration γ2 of the ignition of the mixture is extremely brief (less than 25 ms), but the increased pressure that accompanies it is sufficient to pin the substance flat against the wall of the mold 5, thus forming the container 2.

A third operation, known as primary stabilization, consists of maintaining in container 2 a residual gas (essentially a mixture of water vapor coming from the combustion of hydrogen, with possible traces of NO_{X}), for a predetermined duration γ3 (between 200 and 300 ms) while keeping all the electromagnetic valves EV1, EV2, EV3, EV4 closed, so as to permit the reduction of the temperature and the pressure in the container (FIG. 5E).

A fourth operation, known as degassing, consists of degassing container 2, by closing fourth electromagnetic valve EV4 for a preset duration 4 (between 100 and 200 ms), to allow the air to escape (FIG. 7F) until the pressure prevailing inside container 2 has attained about the atmospheric pressure (FIG. 8B, line 5).

A fifth operation, known as secondary pre-blowing, consists of re-opening electromagnetic valves EV1 and EV2 to introduce into the container an air and reactive gas mixture at a pressure between approximately 5 and 20 bars (FIG. 7G, lines 1 and 2 on FIG. 8B). This fifth operation, of a predetermined duration γ5 (less than 250 ms) ends by the closing of the electromagnetic valves EV1 et EV2 after the pressure in container 2 has reached a value between 5 and 20 bars.

A sixth operation, known as ignition, consists of igniting the gaseous mixture by ignition of spark plug 36 (FIG. 7H, line 3 in FIG. 8B). Taking into account the proportion of hydrogen in the mixture, an explosion is produced in container 2, which is accompanied by an abrupt increase in the temperature (which again reaches several hundred degrees Celsius) and the pressure (which again exceeds 40 bars, the corresponding peak pressure likewise being clipped in FIG. 8A). As in the primary ignition operation, the duration γ6 of the ignition of the mixture is extremely brief (less than 25 ms).

A seventh operation, known as secondary stabilization, consists of maintaining in container 2 a residual gas (essentially a mixture of water vapor coming from the combustion of hydrogen, with possible traces of NO_{X}), for a predetermined duration γ7 (between 200 and 300 ms), while keeping all the electromagnetic valves EV1, EV2, EV3, EV4 closed, so as to permit the reduction of the temperature and the pressure in container 2 (FIG. 7I).

An eighth operation, known as blowing, consists of opening third electromagnetic valve EV3 to introduce into container 2, via holes 13 arranged in rod 12, high pressure air (between approximately 30 and 40 bars) at ambient temperature and thus keep pinned flat against the wall of mold 5 container 2 formed at the time of the ignition operation (FIG. 7J, line 4 on FIG. 8B). During this blowing operation, of a predetermined duration γ8 (preferably less than 300 ms), the fourth electromagnetic valve EV4 is kept closed.

A ninth operation, known as sweeping, consists of making an air sweep of the container, while keeping third electromagnetic valve EV3 open to continue introducing high pressure air (FIG. 8B, line 4) at ambient temperature into container 2, while simultaneously opening fourth electromagnetic valve EV4 to permit pressurized air to be evacuated (FIG. 8B, line 5). An air circulation is thus generated in container 2 while maintaining it under pressure (between 10 and 15 bars), which continues to pin it flat against the wall of mold 5 while cooling it (at least on the side of its inside wall 42), so that upon emerging from mold 5 it retains the shape that the latter gives it (FIG. 7K). This sweep operation is performed for a predetermined duration γ9, between 200 et 2000 ms.

A tenth operation, known as secondary degassing, consists of degassing container 2, by closing third electromagnetic valve EV3 (FIG. 8B, line 4) and leaving fourth electromagnetic valve EV4 for a preset duration γ10 (between 100 and 500 ms), to allow the air to escape (FIG. 7L) until the pressure prevailing inside container 2 has about attained the atmospheric pressure (FIG. 8B, line 5). At the end of this operation, the fourth electromagnetic valve EV4 is closed, the mold 5 opened and the container 2 removed to enable repetition of the cycle with a new preform.

DSC was used, in the above described conditions, to measure the crystallinity in the thickness of a container 2 obtained by this process. The results of the measurements are presented in the following table:

| Segment | Crystallinity (%) |
|---|---|
| A (inside wall) | 15 |
| B | 30 |
| C | 26 |
| D | 27 |
| E (outside wall) | 28 |

It is noted that container 2 exhibits a negative gradient of crystallinity in the area of its inside wall 42. The crystallinity measured from the side of inside wall 42 is in this case much less (about 50%) than the crystallinity measured from the side of outside wall 43.

It may also be noted that the mechanical resistance to deformation of such a container 2, at the time of a hot filling (with a liquid, the temperature of which is between 85° C. and 95° C.), is greater than that of a container obtained by a process without ignition (See, the comparative example). In fact, for a liquid temperature between 85° C. and 95° C., the retraction rate of the container is less than or equal to 1%.

This phenomenon can be explained as follows. The extreme temperature conditions (that reach several hundred degrees Celsius) and the pressure prevailing within container 2 over the course of the formation at the time of the explosion induced by the ignition of the explosive gaseous mixture cause the fusion of the material at least on the side of the inside wall 42 of container 2.

Following the explosion, formed container 2 undergoes a thermosetting, from the side of its outside wall 43 in contact with the heated wall of mold 5. It thus benefits, over a certain thickness from its outside wall 43, from a contribution of crystallinity by thermal means, while its inside wall 42, which becomes completely (or almost completely) amorphous following its fusion, retains a high proportion of amorphous matter, with a comparatively lower rate of crystallinity.

Despite the low rate of crystallinity of the surface of the inside wall 42, the high rate of crystallinity of the surface of outside wall 43 gives the container 2 a rigidity equivalent to that of a container with constant crystallinity (such as a simply thermoset container, obtained by the process described in the comparative example, that is to say without igniting an explosive gaseous mixture), the portion of high crystallinity matter (comprising the outside wall 43) acting in the manner of a brace with respect to the portion of low crystallinity matter (comprising the inside wall 42).

In this example, the thickness of inside wall 42 corresponds to the thickness of the segment A as cut out for the needs of the DSC analysis (See above). The measurements have shown that the crystallinity gradient did not extend beyond segment C. Consequently, the inside wall 42 affected by the negative crystallinity gradient exhibits a thickness less than 100 μm and more likely less than approximately 50 μm.

During the hot filling, the residual stresses stored by the container 2 at the time of its formation are largely released into the amorphous matter present in a large proportion of the side of inside wall 42, which thus acts as a buffer in relation to the portion of high crystallinity matter, preventing the propagation of deformations in the container.

In order to verify the amorphous character of layer A, a thermal analysis was performed on this container 2 by means of DSC, by taking a sample similar to that used for measuring the crystallinity and by cutting it in the same manner to obtain five similar segments A, B, C, D and E. The DSC curves of the five segments are consolidated on the thermogram of FIG. 15. It is apparent that the curves of segments B, C, D and E all exhibit a single peak endothermic fusion around 250° C., while the curve of segment A exhibits, in addition to this same endothermic peak around 125° C., an exothermic peak around 250° C.

This endothermic peak, found between the vitreous transition temperature (occurring around 80° C.) and the fusion peak, is a crystallization peak, attesting to the amorphous character of the matter of segment A, of the side of inside wall 42 of container 2. Conversely, the absence of such a crystallization peak on the curves of the other segments B to E attests to the semi-crystalline character of the matter in particular of the side of the outside wall 43. In other words, container 2 can be considered, at the end of its manufacture, to be amorphous on the side of its inside wall 42.

By comparison, the same analysis was performed on a sample taken from a container obtained by the process described in the comparative example (that is to say without igniting an explosive gaseous mixture). It is apparent (FIG. 16) that the DSC curves of the five segments A to E of the sample exhibit only one, peak, endothermic, corresponding to the fusion of the matter at about 250° C., indicating that the container is semi-crystalline throughout its thickness, including on the side of its internal wall.

### EXAMPLE 4

### FIGS. 9A to 9K, 10A and 10B

In this example mold 5 is heated such that it exhibits on the side of its inside wall a temperature of approximately 130° C. The material of the preform 3 is a PET. The reactive gas is hydrogen (H₂). The air/hydrogen gaseous mixture is made by complying with a hydrogen proportion by volume between 4% and 18%, preferably 6%.

Following introduction of the hot preform 3 into mold 5, a first operation, known as primary pre-blowing, consists of stretching preform 3 by sliding rod 12 and simultaneously pre-blowing it by opening first electromagnetic valve EV1 to introduce into preform 3 an air and reactive gas mixture at a pressure between approximately 5 and 20 bars (FIGS. 9A to 9C, line 1 on FIG. 10B). This first operation of a predetermined duration δ1 (less than 250 ms) ends by the closing of electromagnetic valve EV1 and after rod 12 has ended its travel, having reached mold bottom 7 and the threshold for the plastic outflow of the material has been exceeded (which is indicated on the pressure curve by a first pressure peak, at approximately 8 to 10 bars).

A second operation, known as blowing, consists of blowing container 2 by opening third electromagnetic valve EV3 to introduce into container 2 being formed, via holes 13 arranged in rod 12, high pressure air (between approximately 30 and 40 bars) at ambient temperature, so as to keep container 2 pinned flat against the wall of mold 5 (FIG. 9D, line 4 on FIG. 10B). During this blowing operation, of a predetermined duration δ2 (preferably less than 300 ms), fourth electromagnetic valve EV4 is kept closed.

A fourth operation, known as degassing, consists of degassing container 2, by opening fourth electromagnetic valve EV4 for a preset duration δ3 (between 100 and 200 ms), to allow the air to escape (FIG. 9E) until the pressure prevailing inside container 2 has attained about the atmospheric pressure (FIG. 10B, line 5).

A fifth operation, known as secondary pre-blowing, consists of re-opening electromagnetic valves EV1 and EV2 to introduce into container 2 an air and reactive gas mixture at a pressure between approximately 5 and 20 bars (FIG. 9F, lines 1 and 2 on FIG. 10B). This fourth operation, of a predetermined duration δ4 (less than 250 ms) ends by the closing of electromagnetic valves EV1 and EV2 after the pressure in container 2 has reached a value between 5 and 20 bars.

A second operation, known as ignition, consists of igniting the gaseous mixture by ignition of spark plug 36 (FIG. 9G, line 3 in FIG. 10B). Taking into account the proportion of hydrogen in the gaseous mixture, an explosion occurs in container 2, accompanied by an abrupt increase of the temperature (which reaches several hundred degrees Celsius) and of the pressure (which exceeds 40 bars—on the curve of FIG. 10A; the corresponding peak pressure is clipped due to reasons of scale). The duration δ5 of ignition of the mixture is extremely brief (less than 25 ms).

A sixth operation, known as stabilization, consists of maintaining in container 2 a residual gas (essentially a mixture of air and water vapor coming from the combustion of hydrogen, with possible traces of NO_{X}), for a predetermined duration δ6 (between 200 and 300 ms), while keeping all the electromagnetic valves EV1, EV2, EV3, EV4 closed, so as to permit the reduction of the temperature and the pressure in container 2 (FIG. 9H).

An eighth operation, known as secondary blowing, consists of opening third electromagnetic valve EV3 to introduce into container 2, via holes 13 arranged in rod 12, high pressure air (between approximately 30 and 40 bars) at ambient temperature and thus keep pinned flat against the wall of mold 5 container 2 formed at the time of the ignition operation (FIG. 9I, line 4 on FIG. 10B). During this blowing operation, of a predetermined duration δ7 (preferably less than 300 ms), fourth electromagnetic valve EV4 is kept closed.

An eighth operation, known as sweeping, consists of making an air sweep of container 2, while keeping third electromagnetic valve EV3 open to continue introducing high pressure air (FIG. 10B, line 4) at ambient temperature into container 2, while simultaneously opening fourth electromagnetic valve EV4 to permit pressurized air to be evacuated (FIG. 10B, line 5). An air circulation is thus generated in container 2, while maintaining it under pressure (between 10 and 15 bars), which continues to pin it flat against the wall of mold 5, while cooling it (at least on the same side of its inside wall), so that upon emerging from mold 5 it retains the shape that the latter gives it (FIG. 9J). This sweep operation is performed for a predetermined duration δ8, between 200 et 2000 ms.

A ninth operation, known as secondary degassing, consists of degassing container 2, by closing third electromagnetic valve EV3 (FIG. 10B, line 4) and leaving fourth electromagnetic valve EV4 open for a preset duration δ9 (between 100 and 500 ms), to allow the air to escape (FIG. 9K) until the pressure prevailing inside container 2 has about attained the atmospheric pressure (FIG. 10B, line 5). At the end of this operation, the fourth electromagnetic valve EV4 is closed, the mold 5 opened and the container 2 removed to enable repetition of the cycle with a new preform.

DSC was used, in the above described conditions, to measure the crystallinity of a container 2 obtained by this process, from the surface of inside wall 42 of the body 10 (segment A) and of the surface of its outside wall 43 (segment E). The results of the measurements are presented in the following table:

| Segment | Crystallinity (%) |
|---|---|
| A (inside wall) | 25 |
| E (outside wall) | 31 |

It is noted that container 2 exhibits a negative gradient of crystallinity in the area of its inside wall 42. The crystallinity measured on the side of inside wall 42 is in this case much less (about 30%) than the crystallinity measured on the side of outside wall 43.

It may also be noted that the mechanical resistance to deformation of such a container 2, at the time of a hot filling (with a liquid, the temperature of which is between 85° C. and 95° C.), is greater than that of a container obtained by a process without ignition (See, the comparative example). In fact, for a liquid temperature between 85° C. and 95° C., the retraction rate of the container is less than or equal to 1%.

This phenomenon can be explained as follows. The extreme temperature conditions (that reach several hundred degrees Celsius) and the pressure prevailing within container 2 over the course of the formation at the time of the explosion induced by the ignition of the explosive gaseous mixture cause the fusion of the material at least at the surface of the inside wall 42 of container 2.

Following the explosion, formed container 2 undergoes a thermosetting, of the surface of its outside wall 43 in contact with the heated wall of mold 5. It thus benefits, over a certain thickness from its outside wall 43, from a contribution of crystallinity by thermal means, while its inside wall 42, which becomes completely (or almost completely) amorphous following its fusion, retains a high proportion of amorphous matter, with a comparatively lower rate of crystallinity.

Despite the low rate of crystallinity of the surface of the inside wall 42, the high rate of crystallinity of the surface of outside wall 43 gives the container 2 a rigidity equivalent to that of a container with constant crystallinity (such as a simply thermoset container, obtained by the process described in the comparative example, that is to say without igniting an explosive gaseous mixture), the portion of high crystallinity matter (comprising the outside wall 43) acting in the manner of a brace with respect to the portion of low crystallinity matter (comprising the inside wall 42).

In this example, the thickness of inside wall 42 corresponds to the thickness of the segment A as cut out for the needs of the DSC analysis (See above). The measurements have shown that the crystallinity gradient did not extend beyond segment C. Consequently, the inside wall 42 affected by the negative crystallinity gradient exhibits a thickness less than 100 μm and more likely less than approximately 50 μm.

During the hot filling, the residual stresses stored by the container 2 at the time of its formation are largely released into the amorphous matter present in a large proportion of the side of inside wall 42, which thus acts as a buffer in relation to the portion of high crystallinity matter, preventing the propagation of deformations in the container.

### COMPARATIVE EXAMPLE

### FIGS. 11A to 11F, 12A, 12B, 16

In this example, the mold 5 is heated such that such that it exhibits on the surface of its inside wall a temperature of approximately 160° C. The material of the preform is a PET.

Following introduction of the hot preform 3 into the mold 5, a first operation, known as pre-blowing, consists of stretching preform 3 by sliding the rod 12 and simultaneously pre-blowing it by opening first electromagnetic valve EV1 to introduce into preform 3 an air and reactive gas mixture at a pressure between approximately 5 and 20 bars (FIGS. 11A to 11C, line 1 on FIG. 12B). This first operation of a predetermined duration ε1 (less than 250 ms) ends by the closing of electromagnetic valve EV1 after rod 12 has ended its travel having reached the bottom of mold 7 and the threshold for the plastic outflow of the material has been exceeded (which is indicated on the pressure curve by a first pressure peak, at approximately 8 to 10 bars).

A second operation, known as blowing, consists of blowing preform 3 by opening the third electromagnetic valve EV3 to introduce into preform 3, via holes 13 arranged in rod 12, high pressure air (between approximately 30 and 40 bars) at ambient temperature, so as to pin container 2 flat against the wall of mold 5 (FIG. 11D, line 4 on FIG. 12B). During this blowing operation, of a predetermined duration ε2 (between 500 and 1200 ms), the fourth electromagnetic valve EV4 is kept closed.

A third operation, known as sweeping, consists of making an air sweep of container 2, while keeping third electromagnetic valve EV3 open to continue introducing high pressure air at ambient temperature into the container 2 via holes 13 arranged in rod 12 (FIG. 12B, line 4), while simultaneously opening the fourth electromagnetic valve EV4 to permit pressurized air to be evacuated (FIG. 12B, line 5). An air circulation is thus generated in container 2 while maintaining it under pressure (between 10 and 15 bars), so as to pin it against mold 5 (FIG. 12E). This sweep operation is performed for a predetermined duration ε3, between 500 et 800 ms.

A fourth operation, known as degassing, consists of degassing container 2, by closing third electromagnetic valve EV3 (FIG. 12B, line 4) and leaving the fourth electromagnetic valve EV4 open for a preset duration ε5 (between 100 and 500 ms), to allow the air to escape (FIG. 11F) until the pressure prevailing inside container 2 has attained about the atmospheric pressure (FIG. 12B, line 5). At the end of this operation, the fourth electromagnetic valve EV4 is closed, the mold 5 opened and the container 2 removed to enable repetition of the cycle with a new preform.

DSC was used, in the above described conditions, to measure the crystallinity of a container obtained by this process, from the side of the inside wall of the body of the container (segment A) and in the area of its outside wall (segment E). The results of the measurements are presented in the following table:

| Segment | Crystallinity (%) |
|---|---|
| A (inside wall) | 31 |
| B | 24 |
| C | 28 |
| D | 35 |
| E (outside wall) | 30 |

It is apparent that the crystallinity is more or less constant from segment A (inside wall 42) up to segment E (outside wall 43), demonstrating the more or less uniform character, in the thickness of container 2, of the thermosetting realized by this process.

A thermal analysis of this container 2 is performed by DSC, by taking a sample similar to that used for measuring the crystallinity and by cutting it in the same manner to obtain five similar segments A, B, C, D and E. The DSC curves of the five segments are consolidated on the thermogram of FIG. 16. It is apparent that the curves all exhibit a single endothermic peak of fusion around 250° C., attesting to the semi-crystalline character of the matter throughout the thickness of container 2.

It may also be noted that the mechanical resistance to deformation of such a container 2, at the time of a hot filling (with a liquid, the temperature of which is between 85° C. and 95° C.), is less than that of a container obtained by a process with ignition. For a liquid temperature of 90° C. for example, the retraction rate of the container is 2%. Moreover, for a liquid temperature of 95° C., filling is impossible unless the container 2 is deformed (the container is expanded like a barrel) beyond what is commercially acceptable.

### BIBLIOGRAPHY

[1] J. P. Trotignon, J. Verdu, A. Dobraczynski, M. Piperaud, “Matières plastiques: structure-propriétés, mise en oeuvre, normalisation [Plastic materials: structure-properties, implementation, standardization]”, Ed. AFNOR/NATHAN, Paris 1996, ISBN Nathan 2-09-176572-4
[2] Y. Marco, “Caractérisation multi-axiale du comportement et de la microstructure d'un semi-cristallin: application au cas du PET [Multi-axial characterization of the behavior and of the microstructure of a semi-crystalline: application in the case of the PET]”, Doctoral thesis of the Ecole Normale Supérieure de Cachan, June 2003
[3] M. Chaouche et F. Chaari, “Cristallisation du poly(éthylène téréphtalate) sous élongation: étude in-situ par diffraction de R.X et polarimétrie optique [Crystallization of poly(-ethylene terephthalate) under elongation: in-situ study by R.X. diffraction and optical polarimetry],” in Rheology, Vol. 6, 54-61 (2004)
[4] M. Chaouche, F. Chaari, J. Doucet, Polymer, 44, 473-479 (2003) “Crystallization of poly(-ethylene terephthalate) under tensile strain: crystalline development versus mechanical behavior>>, in Polymer, 44 (2003), 473-479
[5] A. Mahendrasingam, D. J. Blundell, C. Martin, W. Fuller, D. H. MacKerron, J. L. Harvie, R. J. Oldman, R. C. Riekel, “Influence of temperature and chain orientation on the crystallization of poly(ethylene terelphtalate) during fast drawing,” in Polymer, 41 (2000), 7803-7814
[6] American patent U.S. Pat. No. 6,767,197 (Schmalbach-Lubeca AG)
[7] French patent FR 2 649 035 (Sidel) and its American equivalent U.S. Pat. No. 5,145,632
[8] American patent U.S. Pat. No. 4,512,948 (Owens Illinois, Inc.)
[9] American patent U.S. Pat. No. 4,476,197 (Owens Illinois, Inc.)
[10] French patent FR 2 595 EV34 (Sidel) and its American equivalent U.S. Pat. No. 4,836,971
[11] European patent EP 1 305 EV18 (Amcor)

1. Polymer container, having an inside wall and an opposed outside wall, the crystallinity rate of which exhibits a negative gradient of the side of the inside wall.

2. Container according to claim 1, in which the crystallinity rate of the inside wall is less than or equal to 25%.

3. Container according to claim 1, in which the crystallinity rate of the side of the outside wall is less than or equal to 30%.

4. Container according to claim 1, in which the crystallinity rate of the side of inside wall is less than approximately 20% to 50% of the crystallinity rate of the outside wall.

5. Container according to claim 1, the inside wall of which exhibits a thickness less than approximately 100 μm.

6. Container according to claim 5, the inside wall of which exhibits a thickness less than approximately 50 μm.

7. Container according to claim 1, such container being thermoset.

8. Container according to claim 7, the inside wall of which exhibits, on a DSC curve, an exothermic peak between the vitreous transition temperature and a peak of fusion.
